(19) United States
(12) Patent Application Publication
(10) Pub. No.: US 2025/0203433 A1
(43) Pub. Date: Jun. 19, 2025

(54) METHODS, APPARATUS, AND SYSTEMS FOR PROVIDING INFORMATION TO WTRU VIA CONTROL PLANE OR USER PLANE

(71) Applicant: InterDigital Patent Holdings, Inc., Wilmington, DE (US)

(72) Inventors: Morteza Kheirkhah, London (GB); Ulises Olvera-Hernandez, Saint-Lazare (CA); Guanzhou Wang, Brossard (CA); Alec Brusilovsky, Downingtown, PA (US); Zhibi Wang, Woodridge, IL (US); Samir Ferdi, Kirkland (CA)

(73) Assignee: InterDigital Patent Holdings, Inc., Wilmington, DE (US)

(21) Appl. No.: 18/849,028

(22) PCT Filed: Mar. 28, 2023
(86) PCT No.: PCT/US2023/016597

§ 371 Date: Sep. 20, 2024

Related U.S. Application Data
(60) Provisional application No. 63/324,504, filed on Mar. 28, 2022.
(60) Provisional application No. 63/338,646, filed on May 5, 2022.

(51) Int. Cl. H04W 24/10; H04L 41/14; H04W 24/02

(52) U.S. Cl. CPC H04W 24/10; H04L 41/145; H04W 24/02

(57) ABSTRACT

A network node may receive a message indicating one or more analytics parameters to be provided to a wireless transmit/receive unit (WTRU). The information may indicate a method for the network to provide the analytics information to the WTRU. The network node may determine whether to send the analytics information to the WTRU via a control plane or a user plane based on a reporting mode indicated in the message. The network node may send the analytics information to the WTRU via the control plane using a non-access stratum message if the network node determines to send the analytics information via the control plane. The network node may send the analytics information to the WTRU via one or more of a user plane function or an application function if the network node determines to send the analytics information via the user plane.

### CROSS-REFERENCE TO RELATED APPLICATIONS

This application claims priority to U.S. Provisional Patent Application No. 63/324,504 filed in the United States of America on Mar. 28, 2022, and to U.S. Provisional Patent Application No. 63/338,646 filed in the United States of America on May 5, 2022, the entire contents of each of which are incorporated herein by reference.

### BACKGROUND

A Federated Learning (FL) model training may include an FL Application Function (AF). The FL AF may engage in continuous training sessions with a set of participants (e.g., Wireless Transmit/Receive Units (WTRUs)) to train a global machine learning model for a particular objective/task (e.g., such as predicting a user movement). During one or more training session(s), the AF (e.g., the FL AF) may select a set of WTRUs to participate in a distributed training session. The AF may select the set of WTRUs randomly or based on one or more (e.g., some) selection metrics (e.g., all FL-capable WTRUs in a particular geographical location and/or tracking area). After a set of WTRU has been selected, for example, the AF may distribute an initial Machine Learning (ML) model to each participant. The initial ML model may include the neural network (NN) model construction and corresponding weights. This NN model and weights are typically large.

When a WTRU receives the NN model, the WTRU can start a local training according to the application logic. Local training at the WTRU may also constitute several rounds of training (e.g., 1000 iterations). When a required local training is completed, the WTRU may transmit the NN weights to the AF. The transmission of the NN weights may comprise a smaller volume of data compared to the initial model distribution to WTRUs by the AF.

When the AF receives the local trained models from each of the participants/WTRUs, the AF may average the local trained models to generate a global model. If WTRUs are performing well and/or one or more (e.g., all) results arrive at the AF within a predefined time window, the AF can create a global model and/or enter the next training cycle. Additionally or alternatively, having the results from each of the WTRUs may help the global model to converge to its optimal point quicker.

### SUMMARY

Systems, methods and apparatuses are provided herein for Artificial Intelligence (AI)/Machine Learning (ML) operations of a group of wireless transmit/receive units (WTRUs) for federated learning (FL). Systems, methods and apparatuses are provided herein for a Network and Application Traffic Analyzer (NATA) module at a WTRU. Systems, methods and apparatuses are provided herein for an AIML Management Function (AIML-MF) module at a WTRU. Systems, methods and apparatuses are provided herein for enabling interactions between one or more WTRU components and one or more 5G Core (5GC) network functions (NFs) via the user plane. Systems, methods and apparatuses are provided herein for a Packet Train Monitoring Function (PTMF) in a User Plane Function (UPF). Systems, methods and apparatuses are provided herein for a Packet Train Information (PTI) Analytics Network Data Analytics Function (NWDAF). Systems, methods and apparatuses are provided herein for a WTRU Compute Information Analytics NWDAF.

A wireless transmit/receive unit (WTRU) may send a subscription request message to a network node via a user plane function. The subscription request message may indicate one or more analytics identifications (IDs). The one or more analytics IDs may include a packet data unit (PDU) session ID and/or a WTRU ID. The WTRU may receive an analytics request message from the network node via the user plane function. The analytics request message may indicate one or more statistics and/or predictions. The one or more statistics or predictions may include an available bandwidth prediction, level of network jitter, traffic pattern, training epoch, entropy, loss function, training epoch completion time, and/or battery status. The WTRU may determine the one or more statistics or predictions using an AIML-MF. The WTRU may send the one or more statistics and/or predictions to the network node via the user plane function.

The WTRU may request modification of a flow's priority based on the one or more statistics and/or predictions. The WTRU may change a quality of service (QOS) flow by triggering a PDU session modification. The WTRU may move traffic from a first access technology to a second access technology based on the one or more statistics and/or predictions. The WTRU may initiate a PDU session with another application server (AS) based on the one or more statistics and/or predictions. The WTRU may move an Al/ML process from a first processor to a second processor. The WTRU may activate or deactivate one or more radio access network (RAN) resources based on the one or more statistics and/or predictions. The WTRU may determine whether to use a control plane and/or a user plane based on analytics provided by the network.

A network node may receive a message indicating one or more analytics parameters associated with analytics information to be provided to a WTRU. The one or more analytics parameters may include a type of analytics and/or a reporting mode for the analytics. The reporting mode may indicate a method for the network to provide the analytics information to the WTRU. The network node may subscribe to one or more network functions to receive the type of analytics information. The network node may determine whether to send the analytics information to the WTRU via a control plane or a user plane based on the reporting mode indicated in the message. The determination of whether to send the analytics information to the WTRU via the control plane or the user plane may be based on one or more of network congestion information or WTRU mobility information. On a condition that the network node determines to send the analytics information via the control plane, the network node may send the analytics information to the WTRU via the control plane using a non-access stratum (NAS) message. On a condition that the network node determines to send the analytics information via the user plane, the network node may send the analytics information to the WTRU via one or more of a user plane function (UPF) or an application function.

The network node may send a request to the one or more network function(s) indicating the type of analytics information. The network node may be configured to receive the analytics information from the one or more network functions. The one or more analytics parameters may include one or more of: an application identifier (ID); a WTRU ID; data; one or more measurements; one or more reporting anchor network functions (NFs); one or more reporting modes; one or more reporting types; one or more target notification endpoints; and/or a notification correlation ID.

The network node may be configured to enable communication between the WTRU and the UPF via the user plane and to enable communication between the UPF and the network node via the control plane. The reporting mode may include a fixed reporting mode and/or an autonomous reporting mode. The fixed reporting mode may include sending the analytics information to the WTRU via the user plane and/or the control plane using an indicated reporting anchor network function. The autonomous reporting mode may include dynamically selecting a path for sending the analytics information to the WTRU based on one or more congestion, mobility, and/or a policy and charging control (PCC) rule.

A network node may be configured to receive one or more parameters from a WTRU. The network node may determine whether to send information to the WTRU via a control plane or a user plane based on the one or more parameters. The one or more parameters may include one or more of data or analytics provided by an application function or a network function. The network node may update one or more Policy and Charging Control (PCC) rules based on whether the WTRU is authorized to receive the information from the network node. The network node may determine a reporting anchor to use when sending the information based on the one or more updated PCC rules. The network node may send the information to the WTRU via the reporting anchor.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIGS. 2A and 2B depict an example process used to exchange control plane messages between a WTRU and one or more 5G Core network functions.

FIGS. 3A, 3B, and 3C depict an example call flow where an application function (AF) informs the session management function (SMF) regarding the service exposure parameters that have been negotiated between WTRU and AF.

FIGS. 4A and 4B depict an example call flow where the WTRU informs the SMF via non-access stratum (NAS) signaling regarding the service exposure parameters that have been negotiated between WTRU and AF.

FIGS. 5A and 5B depict an example call flow where a WTRU may inform an SMF via NAS signaling and/or where the AF may inform the SMF regarding one or more exposure parameters that have been negotiated between the WTRU and the AF.

### DETAILED DESCRIPTION

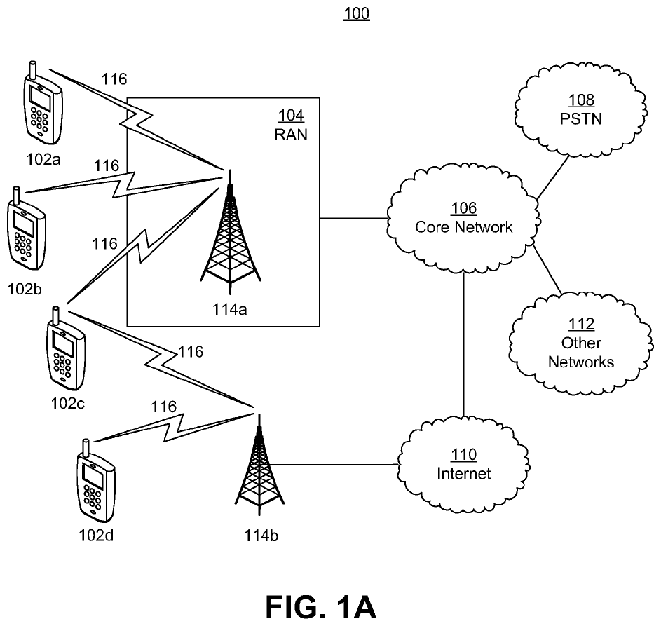

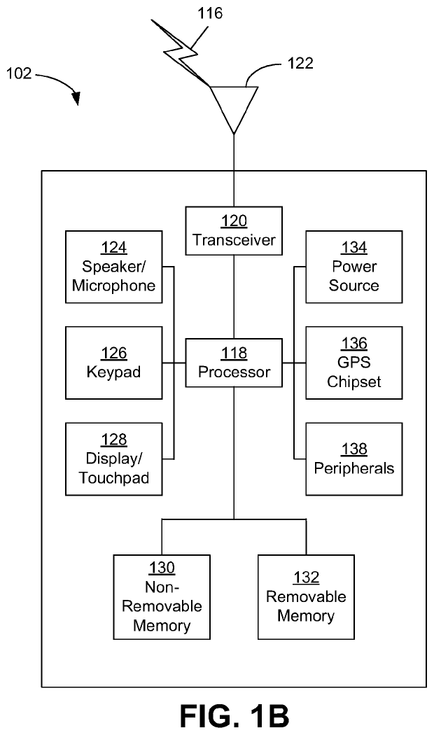

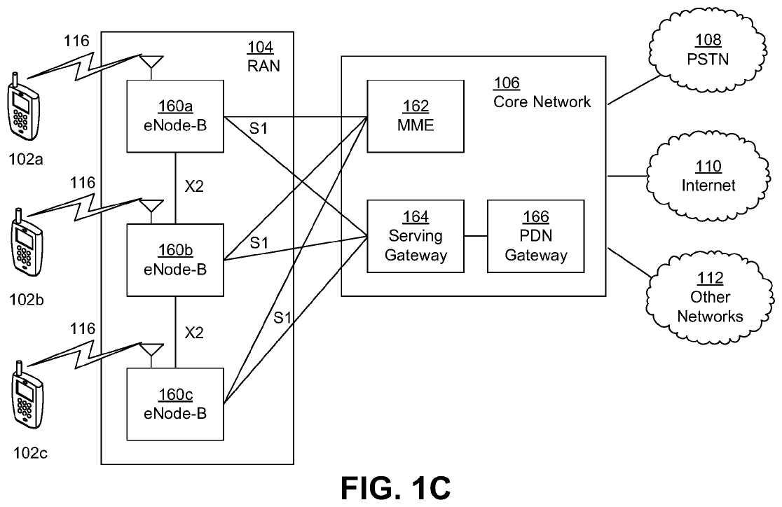

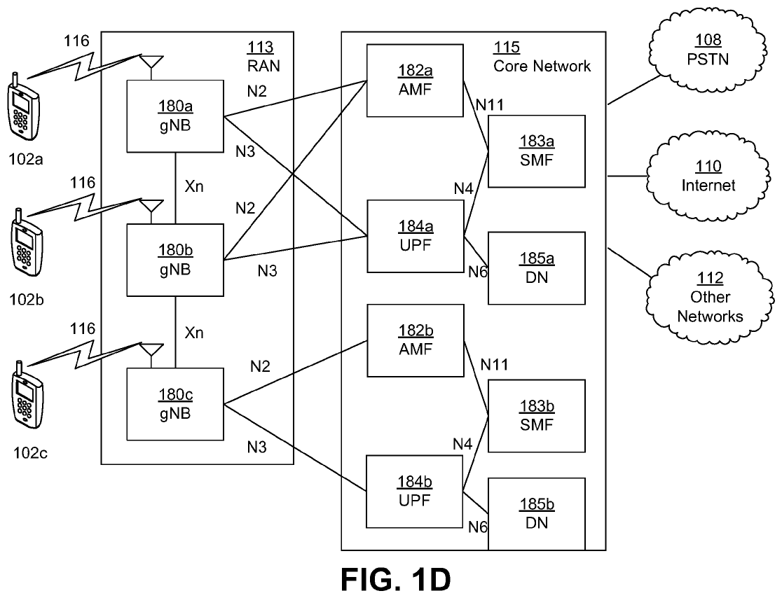

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with one or more of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, e.g., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (e.g., Wireless Fidelity (WiFi), IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHZ channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHZ, 10 MHz and 20 MHz bandwidths in the TV White Space (TVWS) spectrum, and 802.11ah supports 1 MHz, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include one or more of AMF 182a, 182b, one or more of UPF 184a, 184b, one or more Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and apparatuses are provided herein with respect to an interaction mechanism between the WTRU and the UPF. The mechanism may provide the WTRU to send and/or receive information (e.g., predictions, statistics, data, analytics, etc.) from and/or to the one or more network functions in 5GC (e.g., NWDAF) via the UPF. The interaction between the WTRU and the UPF may be performed over the PMF connection, which utilizes the user plane. The PMF may have a client/server architecture (e.g., one instance running at WTRU and UPF) communicating over the TCP/UDP connection. With this interaction model, for example, the UPF may act as an anchor point to relay information between the 5GC NFs and the WTRU (e.g., similar to the NAS signalling). If the UPF also supports Service-Based Interface (SBI), for example, the one or more messages that arrive at the UPF (e.g., from the WTRU) may be delivered (e.g., directly) to their destinations via API calls (e.g., HTTP/2.0). Otherwise, the UPF may deliver the one or more messages via the SMF (e.g., via the N4 interface).

A Network Data Analytics Function (NWDAF) may request the SMF/AMF to collect data from the WTRU through the control plane. In examples, the NWDAF may provide the WTRU ID/PDU Session ID to the SMF/AMF. The AF may use the WTRU Computational Resources analytics and/or one or more other available analytic(s) at the 5GC (e.g., WTRU Communication analytics, DN Performance analytics, slice load level information analytics, etc.) in selecting and/or managing one or more FL participants (e.g., WTRUs).

A Federated Learning (FL) model training may be provided. The FL model training may include an FL Application Function (AF). The FL AF may engage in a plurality of continuous training sessions with a set of participants (e.g., WTRUs) to train a global machine learning model for a particular objective/task (e.g., such as predicting a user movement).

During each training session, the AF (e.g., the FL AF) may select a set of WTRUs to participate in a distributed training session. The AF may select the set of WTRUs randomly and/or based on some selection metrics (e.g., all FL-capable WTRUs in a particular geographical location or tracking area).

After a set of WTRU has been selected, the AF may distribute an initial ML model to each participant. The initial ML model may include the neural network (NN) model construction and/or corresponding weights. This NN model and/or weights may be (e.g., typically) large.

When a WTRU receives the NN model, the WTRU can start a local training according to the application logic. Local training at WTRU may also constitute several rounds of training (e.g., 1000 iteration), which may be done within a specific time window. The WTRU may use its (e.g., sensitive) input data to train its local model during this time. These data may not be shared with other components within the 3GPP system and/or outside.

When a required local training is completed, for example the WTRU may transmit the NN weights to the AF. The transmission of the NN weights may include a smaller volume of data compared to the initial model distribution to WTRUs by the AF.

When the AF receives the local trained models from each of the participants/WTRUs, for example, the AF may average the local trained models to generate a global model. If WTRUs are performing well and/or one or more (e.g., all) results arrive at the AF within a predefined time window, the AF can create a global model and/or enter the next training cycle. Additionally or alternatively, having the one or more result(s) from one or more (e.g., each) of the WTRUs may help the global model to converge to its optimal point quicker.

When a global model is created by the AF, for example, the AF may redistribute the global model to the participants for the next round of training. The AF may select one or more different WTRUs to participate in the next round of training (e.g., training session) during this stage. Poor performing WTRUs may be excluded from this next round of training. The AF may (e.g., intentionally) replace some WTRUs with other WTRUs in a set of continuous training sessions so that the training environment will be changed and/or thus becomes diverse, for example, to achieve diversity in training.

The 3GPP system (3GS) may assist participants/WTRUs participating in an FL's distributed training, for example, so that the participants/WTRUs can complete their local training and/or transfer the completed trained model back to the AF with a small latency.

The latency divergence may be high across participants/WTRUs (e.g., a set of WTRUs may complete their training faster than the other WTRUs and/or a set of WTRUs may deliver their trained local model to the AF/AS faster than the others). In that case, the AF may wait for a small number of WTRUs before it can average one or more (e.g., all) NN weights and/or, in turn, generate a global NN model for the next round of training sessions. The AF may exclude the delayed WTRUs and/or generate a global NN model with a smaller set of WTRUs. However, this approach may result in the training process becoming longer. Therefore, the 3GS may assist one or more (e.g., each) WTRUs to ensure that the WTRU(s) is/are operating within an accepted latency margin. The 3GS may assist the WTRU(s) by considering what information (e.g., measurement, analytics, etc.) can be delivered from 5GC and/or AF to the WTRU and/or a group of WTRUs and/or what actions each WTRU may take to prevent the latency divergence problem.

In one or more (e.g., each) round(s) of the FL training cycle, an ML model may complete a certain number of training epochs (e.g., on average) before the ML model converges to an optimal state where the loss function is minimized while the prediction accuracy is maximized. The actual convergence time of an ML model may depend on several factors, for example, such as training environments, diversity of training environments, datasets, etc.

The 3GS may assist the AF/AS in selecting participants/WTRUs for a training cycle (e.g., the next training cycle). The 3GS (including WTRU and/or 5GC) may provide information (e.g., analytics, statistics, and/or monitoring events) related to the performance/state of a WTRU and/or a group of WTRUs to the AF. The AF may use the provided information to select a set of WTRUs for the next training cycle. The WTRU may signal various information and/or deliver various information to the AF to assist the AF in selection of a set of WTRUs for a training cycle. The 5GC may send information, (e.g., NWDAF, UPF, SMF, and/or AMF) to the AF.

The WTRU and 5GC network functions (e.g., network nodes) may interact with each other, for example, by exchanging statistics, measurements, and/or analytics, without creating significant amount of overhead on the 5G control plane (CP). The WTRU and/or 5GC network functions may determine (e.g., dynamically and/or intelligently) how the 5GC delivers information to the WTRU. For example, the WTRU and/or 5GC network functions may determine whether information should be sent/delivered via CP and/or user plane (UP).

One or more 5GC network functions, such as NWDAF, may collect data from the WTRU through an AF. One or more 5GC network functions, such as NWDAF, may provide one or more predictions and/or statistics to the one or more WTRU(s). The amount of signaling (e.g., signaling overhead) exchanged between the WTRU and the 5GC may become large, especially when a frequent interaction is required. When the amount of signaling becomes large, network congestion within the CP may increase. The WTRU and the 5GC may interact with one another without introducing significant overhead in the CP.

The 3GS may assist AF/AS in managing a group of WTRUs. A group of WTRUs may operate within a network slice. A CP within the network slice may become congested (e.g., due to varied transmission rates of the WTRUs in the group). One or more (e.g., each) WTRU (e.g., in the group) may follow a different sending rate to deliver its respective local train model to the AF/AS. The SMF may engage in load balancing for the WTRUs in the group across different application servers (e.g., replicas), for example, to reduce the load of a particular network slice and/or geolocation. A particular set of rules may be defined at the Policy Control Function (PCF)/SMF, for example, so that appropriate decisions can be made in one or more different circumstances.

Systems, methods, and apparatuses may be provided herein that address how the WTRU ensures that its local ML model training progresses within an acceptable time margin. For example, the WTRU may prevent large delay during the local model training. This may ensure that the latency divergence problem is prevented across one or more WTRUs participating in a FL training session.

The AF may prevent latency divergence across a group of WTRUs that are part of a FL distributed model training. Information provided by the WTRU and/or the 5GC may be used by the AF to select the group of WTRUs, which may be part of the FL operation. Information provided by WTRU and/or 5GC may be used by the AF to manage the group of WTRUs that may be part of the FL operation. The 5G System (5GS), including WTRU and/or 5GC, may ensure that one or more sufficient network resources are allocated to a WTRU in which the locally trained model can be delivered to the AF within an acceptable time margin and/or the global trained model by AF can be delivered to the WTRU within an acceptable latency margin. A WTRU and 5GC may interact with one another while minimizing and/or preventing the CP's network congestion.

A Network and Application Traffic Analyzer (NATA) may be provided in a WTRU. The NATA may comprise an ML-based module that performs network and application traffic analysis at the WTRU. The NATA may monitor the inter-arrival of packets of each application (e.g., such as a PDU Session, a MA-PDU Session, and/or Multiple parallel PDU Sessions). Using the NATA, the WTRU may determine one or more of an end-to-end available bandwidth, a level of jitter in a network path, and/or an overall traffic pattern at different granularities, for example, at the same time.

For example, the NATA may predict the level of end-to-end available bandwidth, the level of network jitter, and/or overall traffic pattern. The NATA may operate on one or more different granularities at the same time (e.g., on per QFI, PDU Session, MA-PDU Session, and/or application basis). The NATA may collect a set of predictions and/or statistics (e.g., load on the network slice) from NWDAF in the 5GC. Similarly, the NATA may provide a set of predictions and/or statistics to the one or more network functions in the 5GC (e.g., NWDAF, AMF, SMF, PCT, and/or AF). In other words, the NATA may be service consumer/provider to the NFs in the 5GC. These one or more interactions may be done either via the NAS signalling (e.g., via the AMF/SMF), the user plane via the UPF, and/or the AF. The NATA may follow one or more similar service(s) and/or service operation(s) used among 5GC's NFs.

The WTRU may use the NATA to collect internal WTRU information (e.g., monitoring traffic at a particular network interface device) and/or 5GC information from one or more 5GC network functions such as NWDAF (e.g., such as slice load level information analytics). With these analytics, the WTRU may have good visibility about the load level on the Network Slice Instance (NSI) that is used. The NSI may be indicated by the S-NSSAI and the associated NSI ID (if applicable). When a FL traffic/operation is handled within a specific network slice, information (e.g., such as predictions) regarding the load on the specific network slice may be used to estimate the end-to-end available bandwidth. Accurate estimation of the end-to-end available bandwidth may prevent latency divergence among a group of WTRUs. Based on the estimated end-to-end available bandwidth, one or more (e.g., each) WTRU(s) may decide to transmit faster and/or move its respective UL traffic to a different PDU session (e.g., different DNN, S-NSSAI) and/or may deliver its respective trained model to the AF/AS within a specific (e.g., preconfigured) time window.

The analytics produced by the NATA may be consumed by the AF (e.g., managing the FL participants/WTRUs and/or operations) and/or the AI/ML Management Function (AILM-MF) at the WTRU. One or more other 5GC NFs can also consume NATA's analytics, for example, by subscribing to the NATA via the AMF/SMF through NAS signaling, the AF, and/or the UPF.

In examples, the WTRU, the 5GC, and/or the AF may consume the User Data Congestion Analytics provided by the NWDAF, to decide which approach to take to communicate with WTRU. Communicating with the WTRU may include exchanging information such as measurements, statistics, predictions, etc. For example, if the 5GC control plane is congested, a WTRU may interact with (e.g., send and/or receive information) the 5GC via UPF and/or AF (e.g., the user plane). When the load in the user plane is high, the WTRU/5GC may exchange (e.g., send and/or receive) information via the control plane.

A WTRU may communicate with the 5GC via the control plane, via the user plane, or both the control plane and the user plane (e.g., in a hybrid mode).

The NAS signaling via the control plane may include the AMF/SMF becoming an anchor point for relaying messages between one or more 5GC NFs and one or more WTRUs (e.g., such as a group of WTRUs). The messages between the one or more 5GC NFs and the one or more WTRUs may be sent over the N1 interface, which may terminate at the AMF. Using the AMF as an anchor point may not create load on the SMF. The one or more NAS interaction(s) via the control plane may be secured, authenticated, and/or integrity protected.

The AF may be the anchor point for relaying messages between a WTRU and one or more 5GC NFs, for example, via the user plane. The WTRU and the 5GC may use the user plane for one or more (e.g., several) interactions (e.g., such as interaction between NWDAF and WTRU for collecting data).

The WTRU may interact with the 5GC via a hybrid mode, where the communication is via both the control plane and the user plane. In examples, the UPF may become an anchor point for relaying one or more messages between a WTRU and one or more 5GC NFs. The UPF, as the anchor point for relaying messages, may be used when there is an established PDU Session and/or the PMF is enabled at both the WTRU and the UPF. With this approach, the WTRU and the UPF may interact via the user plane, while interaction between the UPF and one or more other NFs may be performed via the SMF if the UPF does not support SBI. If the UPF supports SBI, then the interaction between UPF and destination NF can be performed directly (e.g., via an API call) and/or without SMF involvement.

When the NAS signaling is used for reporting the NATA's analytics, a 5GC's NF may invoke an API call (e.g., Namf_EventExposure_Subscribe and/or Nsmf_EventExposure_Subscribe) within AMF/SMF, providing one or more of WTRU ID, PDU Session ID, WTRU's Analytic IDs (e.g., “Network and Application Traffic”, etc.), and/or Notification Target Address (+Notification Correlation ID). For example, the 5GC's NF may send a subscription request message that includes one or more identifiers (e.g., such as analytics IDs).

When the AMF receives the subscription request message, the AMF may rewrite the Notification Target Address (“notifid” and/or “notifUrl”) to its address (e.g., IP address or FQDN). Additionally or alternatively, the AMF may keep the original Notification Target Address within the NAS message, for example, so that the AMF does not require holding any state when a response message for NWDAF is returned from the WTRU. Information provided within the subscription request message may handle one or more (e.g., each) request(s) (e.g., subscription request). Additionally or alternatively, the AMF may associate the WTRU ID and/or PDU Session ID to the original requested Notification Target Address. The mapping between WTRU and NWDAF IDs may enable the AMF to forward a response from the WTRU to the corresponding analytic consumer(s) (e.g., NWDAF) without requiring the WTRU to know the Notification Target Address. The mapping between WTRU and NWDAF IDs may enable sending the response message without exposing the one or more identification(s) of the 5GC NFs to the WTRU.

When a NF subscribes to an event at the AMF, the “event type” may be indicated. In the case of relaying information, an event type may indicate that this event subscription is for the WTRU. The event type may include “WTRU_Analytics_Reporting” and/or “WTRU_Information_Reporting”.

The AMF may create a DL NAS Transport message (e.g., with a new Information Element (IE)). The AMF may send the DL NAS Transport message to the WTRU. The (e.g., new) IE may include the PDU Session ID, Analytics IDs, and/or Notification Target Address (e.g., the AMF address). In examples, when the WTRU receives the NAS message at the MM-Layer (e.g., a termination point of N1 interface at WTRU), the WTRU may forward the payload of the NAS message to the NATA, for example, using the information provided in the DL NAS Transport message (e.g., particularly Analytics ID and the name of API to call, e.g., AnalyticsSubscription_Subscribe). The MM-layer may determine which application/component at WTRU corresponds to the provided Analytics ID(s). Thus, the MM-layer may determine its address (e.g., IP Address, FQDN, etc.).

When the NATA produces the requested analytics by a consumer in 5GC, for example, the NATA may notify the AMF over the N1 interface through a NAS message (e.g., the UL NAS Transport). The AMF may relay the content of the NAS message to its destination (e.g., directly) via an API call (e.g., Namf_EventExposure_Notify). If the AMF is not supported to hold one or more (e.g., any) state to do these relaying tasks, for example, the WTRU may include the address of the NWDAF (e.g., IP address, FQDN, etc.) in the NAS message. The address of the NWDAF may be provided in the subscription request message (e.g., Target Notification Address). If the AMF holds one or more (e.g., some) states (e.g., a mapping between data and/or analytics consumers and/or providers), the address of consumer NF in 5GC may not be shared with the WTRU.

A WTRU may send and/or receive information (e.g., predictions, statistics, data, analytics, etc.) to and/or from the one or more network functions in 5GC (e.g., NWDAF) via the UPF. The interaction between the WTRU and the UPF may be performed over the PMF connection, which utilizes the user plane. The PMF may have a client/server architecture (e.g., one instance running at WTRU and UPF) communicating over the TCP/UDP connection. With this interaction model, for example, the UPF may act as an anchor point to relay information between the 5GC NFs and the WTRU (e.g., similar to the NAS signalling). If the UPF also supports Service-Based Interface (SBI), for example, the one or more messages that arrive at the UPF (e.g., from the WTRU) may be delivered (e.g., directly) to their destinations via API calls (e.g., HTTP/2.0). Otherwise, the UPF may deliver the one or more messages via the SMF (e.g., via the N4 interface).

In examples, the WTRU may notify the analytics consumer (e.g., such as the NWDAF) via the UPF if the PMF is enabled at the UPF and/or the WTRU. The WTRU may deliver information to 5GC through the user plane instead of the control plane, for example, to prevent congestion in the control plane. The AMF/SMF may indicate the Target Notification Address of the PMF/UPF in the subscription request message, for example, that may be carried in the DL NAS Transport. The information regarding the NWDAF address and/or the UPF/PMF address may be carried in the DL NAS Transport generated by the AMF/SMF.

In examples, the NWDAF may request subscription to (e.g., directly ask) the UPF/PMF to subscribe to get a WTRU's analytics. This way, interaction (e.g., all interaction) between the WTRU and the 5GC may be performed via UPF, and thus the UPF may include a mapping between the address of the data and/or analytic consumer(s) and the one or more providers (e.g., NWDAF address and WTRU's application address), PDU Session ID, etc.

When the UPF (PMF) receives a WTRU message (e.g., the subscription request message), the UPF may then relay the WTRU message (e.g., directly) to the corresponding consumer(s) if the UPF supports SBI. The WTRU message may be delivered to the analytics consumer(s) via the SMF (e.g., via the N4 interface).

Exchanging control messages (e.g., including analytics, measurements, and/or statistics) between a WTRU and a UPF may have one or more (e.g., several) advantages. Exchanging control messages between the WTRU and the UPF may significantly prevent congestion in the 5GC control plane. Data exchanged between the WTRU and the UPF may be sent within an established PDU Session. The established PDU session may be authenticated, secured, and/or integrity protected.

The PMF may function within the ATSSS framework which enables multi-connectivity. With the PMF, which has a client/server architecture, the 5GC can perform one or more (e.g., some) measurements between the WTRU and the UPF over the MA-PDU Session (e.g., over the user plane). The one or more measurements may include RTT, packet loss rate, and/or packet error rate. The PMF may be utilized for exchanging data, analytics, and/or one or more measurements between the WTRU and the 5GC. The 5GC control plane may not be (e.g., completely) flooded by control messages between one or more WTRUs and the 5GC because, for example, interaction between WTRUs and the UPF can be made through the user plane. The 5G control plane may be affected (e.g., control message traffic may be reduced) when the one or more WTRUs and the UPF communicate via the user plane. 5G control plane congestion may be reduced when the UPF supports service base interface (SBI) in which the message can be forwarded to its destination without passing through SMF (e.g., using the control plane).

During a registration procedure, the WTRU may inform the 5GC that the WTRU can provide such capability(ies) (e.g., providing analytics, statistics, and/or measurements) by providing the corresponding Analytics IDs and/or their respective descriptions. This information may be saved in UDM, which can then be used by AMF/SMF (e.g., or other NFs). For example, during the PDU Session Establishment, the AMF/SMF (or other NFs) may verify the one or more respective capability (ies) of the one or more WTRUs. The AF may use the analytics, statistics, and/or measurements to select a set of WTRUs, for example, because the AF can query 5GC (e.g., UDM) to get all available WTRUs with such capabilities in a particular area of interest (e.g., TA, cell, geographical location, etc.). If such capabilities are not recorded in the 5GC during the WTRU registration, for example, the WTRU may enable the one or more capabilities (e.g., statistics, analytics, and/or one or more measurement(s) provided by the WTRU during a PDU Session Establishment and/or Modification procedures via (e.g., new) IE in corresponding one or more NAS messages.

In examples, the NATA may follow NWDAF-like service operations for subscribing and/or unsubscribing to the analytics. The NATA may follow NWDAF-like service operations to allow the interactions between the WTRU and the 5GC NFs to be performed in a harmonious way in which applications running at the WTRU can be looked at as part of 5GC and the other way around. Examples of such service operations are provided herein in Table 1.

TABLE 1
The NATA's service operations and their corresponding
operation semantics and/or one or more (e.g., some) examples
of which components within 5GS can subscribe to it.

| | Service | Operation | Example |
|---|---|---|---|
| Service Name | Operations | Semantics | Consumer(s) |
| Nnata_AnalyticsSubscription | Subscribe | Subscribe/ | AMF, SMF, |
| | Unsubscribe | Notify | NWDAF, UPF |
| | Notify | | AF, WTRU's |
| | | | internal |
| | | | components |
| | Transfer | Request/ | NWDAF, other |
| | | Response | WTRU's |
| | | | internal |
| | | | components |

An AIML Management Function (AIML-MF) may be provided at a WTRU. The AIML-MF may handle and/or optimize one or more AI/ML operations running at the WTRU. For example, the AIML-MF may optimize operations associated with an FL application running at WTRU. The AIML-MF may prevent latency divergence problems across a group of WTRUs and/or ensure that a local FL training model is completed and/or transferred to the AF/AS within an acceptable (e.g., preconfigured) time window. The AIML-MF may run at the application layer, and/or may follow similar service operations used in 5GC (e.g., NaimImf_EventExposure and/or Naimlmf_AnalyticsSubscribe, etc.).

One or more AI/ML applications may interact with the AIML-MF and/or communicate their required optimizations (e.g., requirements, constraints, and/or other real-time application specific information such as traffic pattern changes and/or bitrate changes). The AIML-MF may attempt to optimize the one or more 5GS resource(s) to meet one or more (e.g., each) Al/ML application's objectives (e.g., meeting application-specific objectives such as completing a task within a specific time-window). The AIML-MF may interact (e.g., communicate) with the MM-layer to initiate standard NAS signaling such as initiating a PDU Session Modification/Release procedure, sending/receiving the UL/DL NAS Transport, and/or initiating a WTRU Registration procedure.

The AIML-MF collects information (e.g., data, statistics, and predictions) from WTRU and/or NFs in 5GC and/or the AF. The AIML-MF may collect one or more statistic(s) regarding AI/ML operations from the WTRU's application (e.g., training epoch, entropy, loss function). The AIML-MF may collaborate with the AF (e.g., by exchanging information), for example, to meet one or more objectives. The AIML-MF may assist the AF in managing a group of WTRUs participating in federated learning operations and/or selecting a set of participants/WTRUs for a training cycle (e.g., the next training cycle).

Additionally or alternatively, the AIML-MF may incorporate one or more other available analytics/statistics at the WTRU (e.g., the NATA predictions) and/or elsewhere (e.g., NWDAFs in 5GC) in order to optimize the one or more AI/ML operation(s) running at the WTRU.

The AIML-MF may inform the AF regarding the optimization actions that have been taken by the WTRU either directly or via the corresponding application running at WTRU. The AIML-MF may retrieve one or more of the following analytics from the NWDAF: User Data Congestion (network related), WTRU Mobility (e.g., predicting the number of handovers, etc.), Load level information (e.g., predicting the load level on network slice, etc.), WLAN performance (e.g., predicting WLAN performance of WTRU in the case the WTRU has non-3GPP access or using the ATSSS framework with WLAN), and/or WTRU Compute Information (e.g., predicting the WTRU's CPU/GPU and memory's usage).

The AIML-MF may collect one or more essential analytics at the WTRU which include Network and Application Traffic Analysis (e.g., predicting the end-to-end available bandwidth, level of network jitter, and traffic pattern).

The AIML-MF may collect one or more of the following statistics at the WTRU: Application specific statistics and measurements such as training epoch, entropy, loss function, training epoch completion time, etc, and/or battery status.

The AIML-MF may request to change a flow's priority from 5GC by changing QoS flow (e.g., 5QI, ARP, etc.), for example, by triggering the PDU Session Modification procedure. The AIML-MF may move traffic from one access technology to another in the case WTRU supports multi-access technologies (3GPP and non-3GPP such as WiFi). The AIML-MF may move the traffic over an MA-PDU Session and/or parallel PDU Sessions. In the latter case, the WTRU may open multiple PDU Sessions with different characteristics (e.g., QoS profile, S-NSSAI, DNN, etc.). To open multiple PDU sessions with different characteristics, the AIML-MF may dynamically update ATSSS and/or URSP rules. When the AIML-MF has updated these rules dynamically at the WTRU, the AIML-MF may inform 5GC (more precisely the SMF/PCF). The AIML-MF may initiate a (e.g., new) PDU Session towards a (e.g., new) AS, for example, in a scenario where a current AS is expected to be not the best choice. This is a common scenario where WTRU changes location, or the current AS load is high. The AIML-MF may switch an AI/ML process from CPU to GPU, for example, to speed up model training (e.g., to be completed within a specific time window) and another way around to save WTRU's energy. The AIML-MF may activate/deactivate RAN resources to save energy and radio resources. Activating/deactivating RAN resources may be executed via a PDU Session Modification procedure.

A WTRU may use the UPF to exchange control plane messages. The AIML-MF may request to get predictions related to the end-to-end available bandwidth and jitter from the NATA component at WTRU. The NATA may request a prediction regarding the level of load on the network slice used for the AIML application. The AIML application considered in this example is running federated learning.

An interaction mechanism between the WTRU and the UPF may be provided. For example, the WTRU may send and/or receive information (e.g., predictions, statistics, data, analytics, etc.) to/from one or more network functions in 5GC (e.g., such as the NWDAF) via the UPF. The interaction between the WTRU and the UPF may be performed over the PMF connection, which utilizes the user plane. The PMF has a client/server architecture. For example, the PMF has one instance running at the WTRU and another instance running at the UPF. The PMF instances may communicate over the TCP/UDP connection. With this interaction model, the UPF may act as an anchor point to relay information between one or more 5GC NFs and a WTRU (e.g., similar to the NAS signaling). If the UPF supports Service-Based Interface (SBI), the messages that arrive at the UPF (e.g., from the WTRU) may be delivered directly to their destinations via API calls (e.g., HTTP/2.0). Otherwise, the UPF may deliver the messages via the SMF (e.g., via the N4 interface).

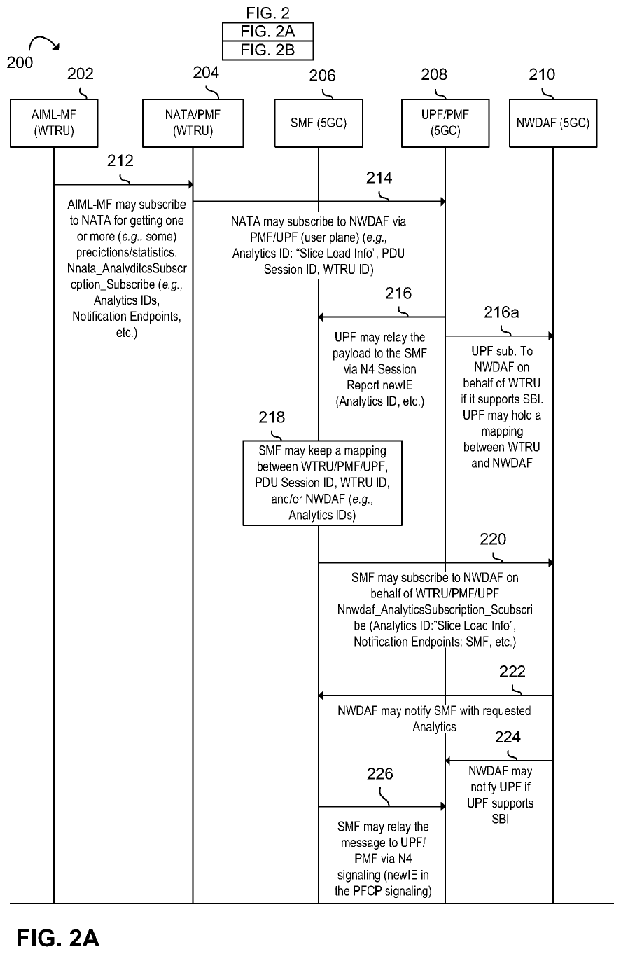

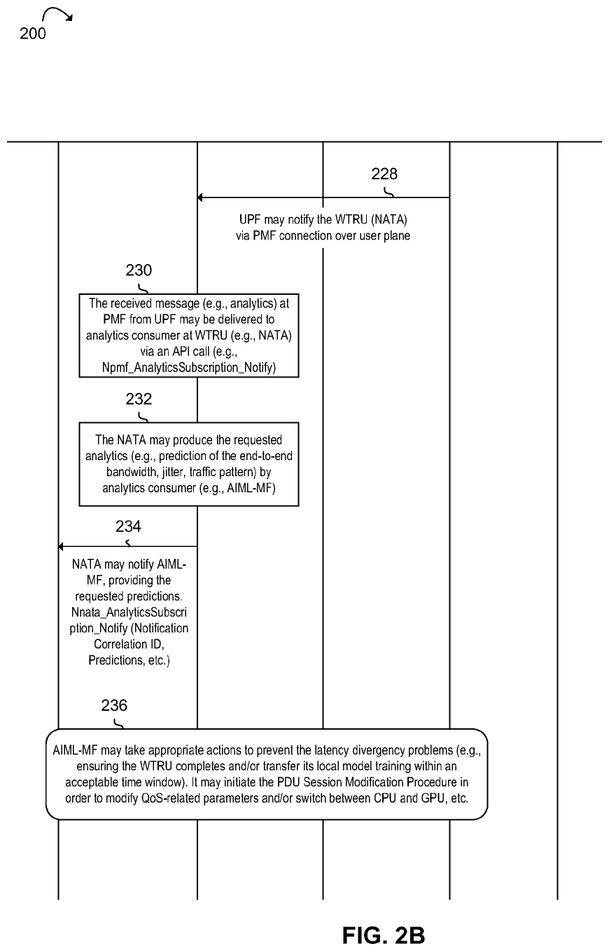

FIGS. 2A and 2B depict an example call flow procedure 200 used to exchange control plane messages.

At 212, the AIML-MF 202 may subscribe to the NATA component 204 at WTRU to get one or more (e.g., some) prediction(s) regarding the end-to-end available bandwidth, level of end-to-end jitter for DL/UL, and/or traffic pattern. To subscribe to the NATA 204, the AIML-MF 202 may invoke the Nnata_AnalyticsSubscription_Subscribe service operation, providing desired Analytics ID(s), Target Notification Endpoints (e.g., AIML-MF IP address and/or an AF IP address), S-NSSAI, PDU Session ID, etc. For example, the AIML-MF 202 may send a subscription request message 212 to the NATA 204 that includes one or more analytics IDs. When the AF IP address is also provided in the subscription request message 212, the AF may also be notified by the NATA 204.

At 214, the NATA may determine whether to collect one or more (e.g., some) data and/or analytics from elsewhere (e.g., WTRU and/or 5GC NFs). In examples, the NATA 204 may determine to collect data regarding the inter-arrival gaps of a PDU Session's packets in DL/UL. Additionally or alternatively, the NATA 204 may collect (e.g., regularly collect) information regarding the load prediction on a network slice instance. To do that, the NATA 204 may invoke an API at the PMF 208 component at the WTRU which is connected to UPF via the user plane (e.g., Npmf_AnalyticsSubscribe_Subscribe). The NATA 204 may provide one or more desired Analytics ID(s) (e.g., PDU Session ID, WTRU ID, etc.) to subscribe.

The UPF 208 may either directly or indirectly (e.g., via SMF 206) forward the subscription request message (e.g., the payload of the subscription request message) to an NWDAF instance, for example, based on whether the UPF 208 supports SBI. In the case of SMF 206, the UPF 208 may use an IE in the N4 Session Report procedure to relay this request message at 216. This message may also include information regarding UPF/PMF 208 address (e.g., an address indication).

At 216a, the UPF may invoke Nnwdaf_AnalyticsSubscription_Subscribe service operation, providing Analytics ID(s), Target Notification Endpoints (e.g., PMF/UPF 208 and/or an AF IP address). Additionally or alternatively, the UPF 208 may determine (e.g., and/or store) a mapping between the WTRU ID, PDU Session ID, and/or NWDAF, for example, so that the UPF 208 can (e.g., correctly) relay the one or more notification(s) from the NWDAF 210 to the WTRU via PMF 208. When the AF IP address is also provided in the subscription request message, the AF may also be notified by the NWDAF 210.

At 218, the SMF 206 may determine a mapping between the WTRU ID, PMF 208, UPF 208, PDU Session ID, and/or NWDAF 210 (e.g., Analytics IDs), for example, when the UPF 208 forwards the WTRU's subscription request message via SMF 206. The SMF 206 may subscribe to the NWDAF 210 on behalf of the UPF 208/PMF 208/WTRU.

At 220, the SMF 206 may send a subscription message on behalf of the WTRU (and/or PMF/UPF) to the NWDAF 210, for example, by invoking the Nnwdaf_AnalyticsSubscribe_Subscribe service operation (e.g., directly). This API call may include Analytics IDs (e.g., Slice Load Information), and/or Target Notification Endpoints (e.g., SMF address and/or AF).

At 222, the NWDAF 210 may notify the SMF 206 with the requested predictions and/or statistics. Additionally or alternatively, the NWDAF 210 may notify the UPF 208 (e.g., directly), for example, if the UPF 208 supports SBI (e.g., at 224). The SMF 206 may relay the notification message from the NWDAF to the UPF/PMF via the N4 signaling (e.g., new IE in the PFCP signaling) (e.g., at 226). At 228, for example, the UPF 208 may notify the WTRU (e.g., NATA/PMF 204) by invoking a (e.g., new) API call at PMF.

At 230, the PMF at the WTRU 204 may receive the notification message 228 via the user plane. The PMF may (e.g., then) relay the notification message to NATA 204 by invoking the Npmf_AnalyticsSubscribe_Notify service operation. At 232, the NATA 204 may produce the requested analytics (e.g., predictions/statistics) by one or more analytics consumer(s) which is in this case may be AIML-MF 202. At 234, the NATA 204 may (e.g., then) notify the AIML-MF 202, accordingly, to provide the one or more requested predictions and/or statistics. The NATA 204 may notify the AIML-MF 202 for example, by invoking the Nnata_AnalyticsSubscription_Notify. The NATA 204 may provide the Notification Correlation ID and/or predictions/statistics to the AIML-MF 202 via the notification message at 234.

At 236, the AIML-MF 202 may take one or more (e.g., appropriate) action(s) to prevent latency divergence (e.g., across a group of WTRUs) and/or may ensure that the WTRU completes its local training and/or transmits the trained model to the AF/AS within the specific (e.g., preconfigured) time window. The AIML-MF 202 may initiate the PDU Session Modification procedure to modify one or more QoS related parameters (e.g., 5QI and/or ARP); and/or switching between CPU and GPU; and/or move the FL application traffic from one PDU session to another (e.g., in the case the WTRU has one or more parallel PDU session(s) to one or more different application server(s)); and/or the WTRU initiates the Registration procedure, for example, to change the set of S-NSSAIs.

A set of PCC rules may include information associated with information exposure to the WTRU. The information associated with information exposure may include “Reporting anchor nodes” (e.g., SMF/AMF, UPF/PMF, AF/DCAF), “Reporting mode” (e.g., Autonomous, Fixed), “Reporting types” (e.g., request/response, subscribe/notify), data, one or more measurements, Notification Correlation ID, etc.

An Information Element (IE) in the NAS SM Signaling may be used to carry a service information (e.g., analytics information) request to 5GC.

An SMF functionality may take intelligent decisions regarding which reporting anchor NFs to select under different conditions. In another embodiment, the SMF may subscribe to dedicated analytics (e.g., NWDAF instance) for this purpose.

A set of updates in service operations of PCF may be provided herein (e.g., Npcf_PolicyAuthorization_Create/Update, Npcf_SMPolicy_UpdateNotify), UDM (e.g., Nudm_SDM_Get).

A WTRU may request analytics information from the 5GC, for example using the 5GC Network Exposure Capabilities, including Monitoring and Network Analytics. Information (e.g., analytics information) may be sent from 5GC to WTRU via CP and UP (e.g., a hybrid approach).

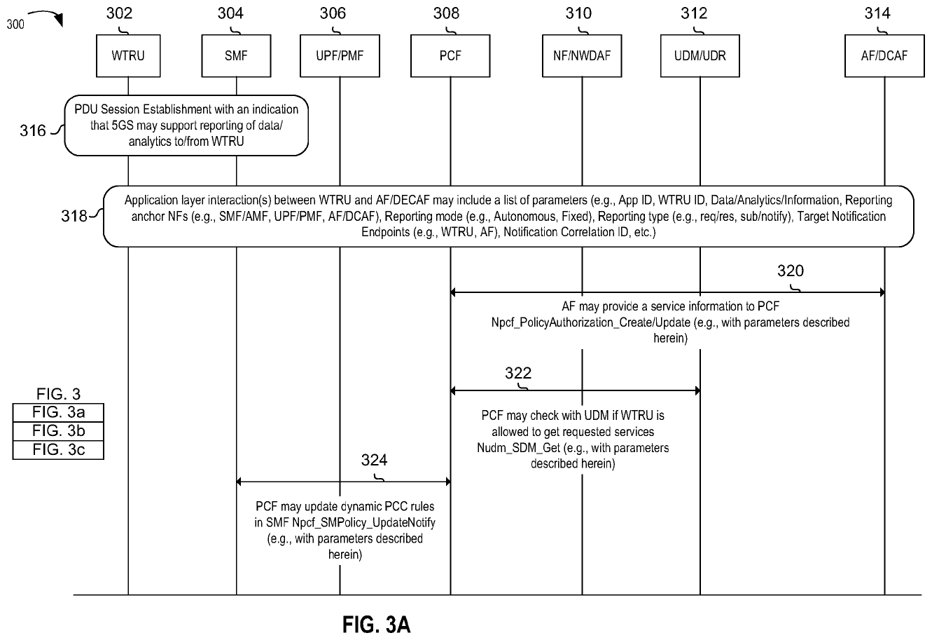

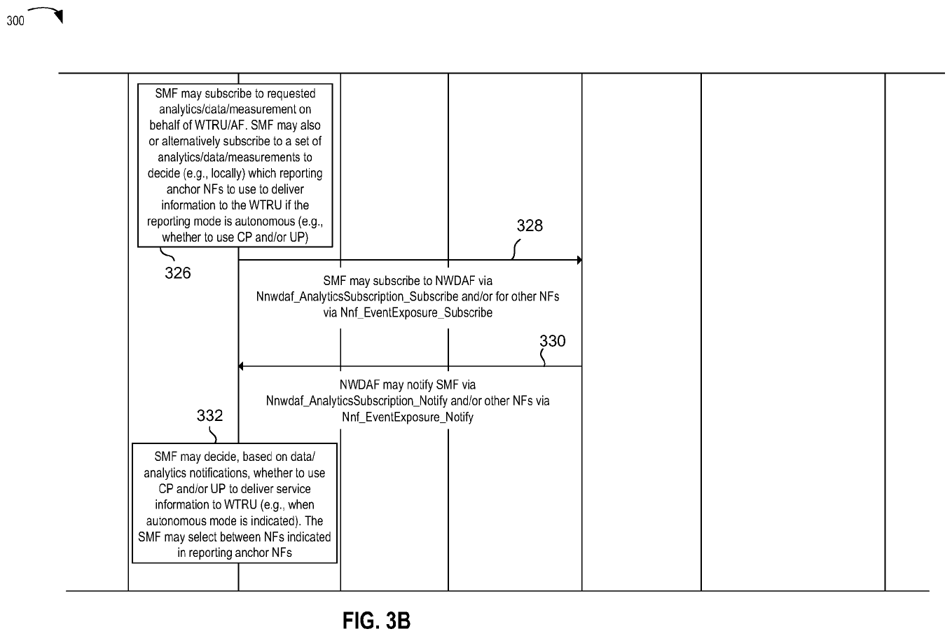

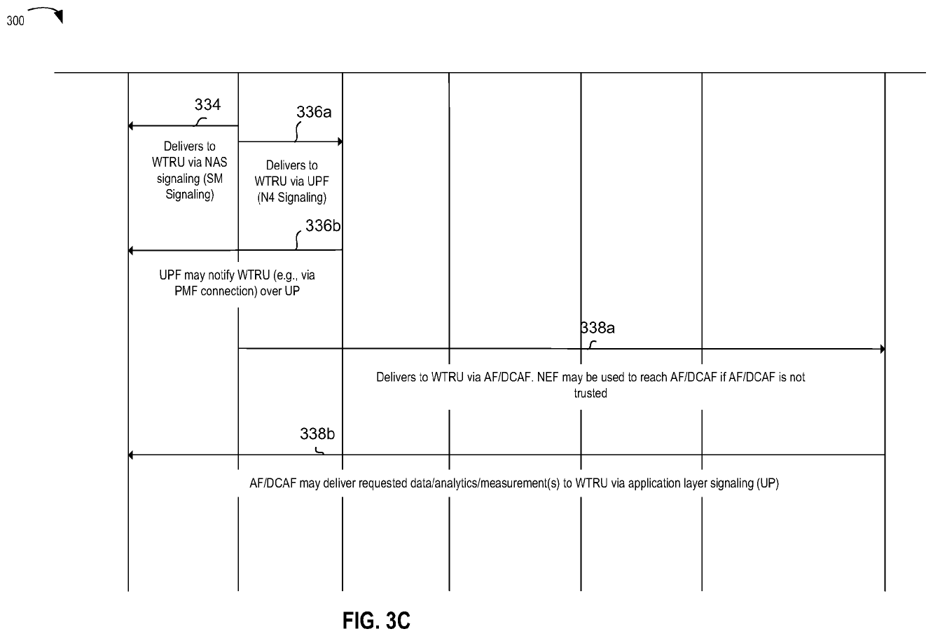

FIGS. 3A, 3B, and 3C depict an example call flow 300 where the AF 314 informs the SMF 304 regarding the service exposure parameters that have been negotiated between WTRU 302 and AF 314. The AF 314 may send service information requests (e.g., on behalf of the WTRU 302 and/or itself 314) to the SMF 304, for example, via the PCF 308. Service information may include analytics information, data, and/or measurement information. In the one or more service information request(s), the WTRU 302/AF 314 may indicate how the SMF 304 should deliver the requested service information to the WTRU 302. For example, the WTRU 302/AF 314 may indicate in the service information request whether to use CP (e.g., via NAS signalling) and/or UP (e.g., directly through the UPF 306, or via AF-UPF-WTRU). The AF 314 may correspond to a Data Collection Application Function. As part of a service information request, for example, the AF 314/WTRU 302 may indicate a reporting mode to the SMF 304. If the reporting mode is “Autonomous”, the SMF 304 may select (e.g., dynamically select) whether to send the service information to the WTRU 302 via the CP and/or the UP, for example, according to a set of specific data and/or analytics that SMF 304 may collect from the 5GC NFs and/or the AF 314. For example, the SMF 304 may determine to send the service information to the WTRU via the UP or CP based on one or more of congestion, mobility, or a PCC rule. If the reporting mode is not provided, a Network Function, e.g., the SMF 304 may use Network Analytics, such Network Slice congestion and/or analytics on data traffic volume, to determine the mode to use when delivering information to the 302 WTRU.

At 316, the WTRU 302 may establish a PDU Session indicating that the WTRU 302 communicate with (e.g., receive/provide information from/to) the 5GC. The SMF 304 may interact with PCF 308 and/or the UDM 306 to verify one or more WTRU permission(s). Verification of the one or more WTRU permissions may be performed as part of a PDU Session Establishment and Modification procedure.

At 318, the WTRU 302 and AF 314 may negotiate regarding what information (e.g., data, analytics information, and/or measurements, etc.) should be exposed to the WTRU 302 and/or the AF 314 and in what ways (e.g., CP and/or UP). The WTRU and AF may exchange one or more parameters (e.g., analytics parameters) when negotiating. The one or more parameters may include Application ID; WTRU ID (e.g., SUPI); data; one or more measurements; Reporting anchor NFs (e.g., SMF/AMF, UPF, AF/DCAF); Reporting mode (e.g., Autonomous or Fixed), Reporting type (e.g., Request/Response or Subscribe/Notify); Target Notification Endpoints (e.g., WTRU, AF); Notification Correlation ID; etc. Data and/or the one or more measurements may include network load, user data congestion, data network performance analytics and/or one or more WLAN performance measurements.

If the Reporting mode is “Autonomous”, the SMF 304 may deliver information to the WTRU 302 via UPF/PMF 306 (UP), SMF 304/AMF (CP), and/or AF/DCAF 314 (UP) dynamically and/or intelligently. The SMF 304 may select a path for delivering information to the WTRU 302 by collecting one or more (e.g., some) (e.g., specific) data and/or analytics from the one or more 5GC NFs (e.g., analytics related to User Data Congestion, User Mobility, etc.). The SMF path selection may be influenced by one or more PCC rule(s) at the SMF 304, which can be created/updated by the PCF 308. If the Reporting mode is “Fixed”, the SMF 304 may send analytics information to the WTRU 302 via a reporting anchor NF using the UP or CP (e.g., AF 314 (UP), SMF/AMF 304 (CP), and/or UPF 306 (UP)).

The one or more target notification endpoints may identify where a notification is destined. For example, the target notification endpoints may include WTRU 302, AF 314, and/or one or more other NFs.

The reporting type may identify what service operation should be used to retrieve from the service producer. The reporting type may include request, response, subscription, and/or, notify.

A Notification Correlation ID may be allocated by the information consumer (e.g., WTRU302/AF 314) that subscribes to event reporting. The notification correlation ID may allow the service consumer to associate the notification from the service producer to a subscription.

At 320, the AF 314 may provide a negotiated service information to the PCF 308, for example, by invoking Npcf_PolicyAuthorization_Create/Update service operation (e.g., including one or more parameter(s) such as Reporting anchor NFs, Reporting mode, Reporting type, requested data and/or analytics and/or one or more measurements, Notification Correlation ID, etc.).

At 322, the PCF 308 may check with the UDM 312 if the WTRU 302 is authorized to get the requested service information from 5GC, for example, by invoking the Nudm_SDM_Get service operation, which may include one or more service and/or analytics parameters such as: Reporting anchor NFs, Reporting mode, Reporting type, requested data and/or analytics and/or one or more measurements, Correlation Notification ID, etc.

At 324, the PCF 308 may update one or more dynamic PCC rule(s) in the SMF 304, for example, once the verification is returned from the UDM 312. The PCF 308 may invoke the Npcf_SMPolicy_UpdateNotify service operation (e.g., including one or more parameter(s) such as Reporting anchor NFs, Reporting mode, Reporting type, requested data and/or analytics and/or one or more measurements, Notification Correlation ID, etc.). One or more PCC rule(s) associated with information exposure to the WTRU 302 may be defined herein. The one or more PCC rule(s) may include information associated with the Reporting anchor NFs, Reporting mode, Reporting type, etc.

At 326, the SMF 304 may be subscribed to requested analytics/data/measurement on behalf of the WTRU 302 and/or the AF 314. If the service producer ID is not indicated by the WTRU 302 and/or the AF 314, for example, the SMF 304 may query the Network Repository Function (NRF) to get the corresponding service producer that is serving the WTRU 302 and/or the AF 314. The NRF may be used to register one or more (e.g., 5GS) Network Function(s) (e.g., NF entity (ies)) with a (e.g., specific) service profile. Registering the one or more network function(s) may enable one or more other NFs in the system to find (e.g., by passing to the NRF the profile of the NF delivering the service) the address of one or more NF entity (ies) providing a (e.g., specific) service. One or more function(s) of a NRF may be similar one or more function(s) of a DNS. Additionally or alternatively (e.g., at 328), the SMF 304 may subscribe to service information (e.g., one or more sets of data, analytics, and/or one or more measurements/statistics) to use when determining which reporting anchor NF(s) should be used to (e.g., better) deliver analytics information to the WTRU 302 when the reporting mode is “Autonomous”. For example, the SMF 304 may determine whether to use NAS signalling and/or user plane (e.g., UPF and/or AF) to deliver information to the WTRU. The SMF 304 may subscribe to analytics information (e.g., such as the User Data Congestion Analytics) to predict how congested the CP would be. Additionally or alternatively, the SMF 304 may subscribe to other analytics information (e.g., such as one or more user mobility analytics) to predict user mobility (e.g., in dual-connectivity scenarios). For subscribing to the NWDAF 310 and one or more other NFs, the SMF 304 may invoke Nnwdaf_AnalyticsSubscription_Subscribe and/or Nnef_EventExposure_Subscribe service operations, respectively.

At 330, the NWDAF 310 and/or one or more other NFs may notify the SMF 304 with requested data and/or analytics and/or measurements. The notification from the NWDAF 310 may include Nnwdaf_AnalyticsSubscription_Notify and/or Nnf_EventExposure_Notify.

At 332, the SMF 304 may determine whether to use CP and/or UP when the autonomous reporting mode and/or one or more (e.g., multiple) reporting anchor NFs are indicated (e.g., SMF 304, AF 314, UPF 306) in the one or more PCC rule(s). If the SMF 304 determines to use CP (e.g., SMF 304), the SMF 304 may deliver the service information from 5GC to the WTRU (e.g., at 334) via NAS signalling (e.g., more specifically via the SM signalling). If the SMF 304 determines to use UP, for example at 336a and 336b, the SMF 304 may deliver the service information via the UPF (e.g., initially via N4 signalling to UPF and (e.g., then) from the UPF 306 to the WTRU 302 via the user plane connection). If the SMF 304 determines to use UP, the SMF 304 may, additionally or alternatively, deliver service information via the AF 314 where initially to the AF 314 (e.g., at 338a) and/or (e.g., then) from the AF 314 to the WTRU 302 (e.g., at 338b) over a user plane connection (e.g., such as application layer signaling). A NEF may be used to reach the AF/DCAF 314, for example, the AF/DCAF 314 is not trusted (e.g., at 338a). The AF/DCAF 314 may deliver one or more requested data and/or analytics and/or one or more measurement(s) to the WTRU 302 via application layer signalling (UP) (e.g., at 338b).

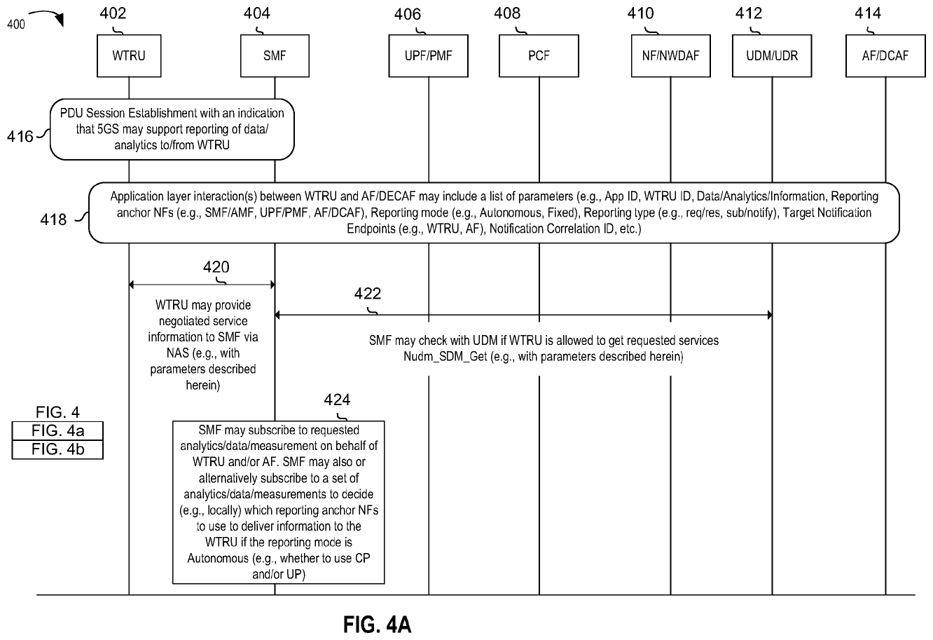

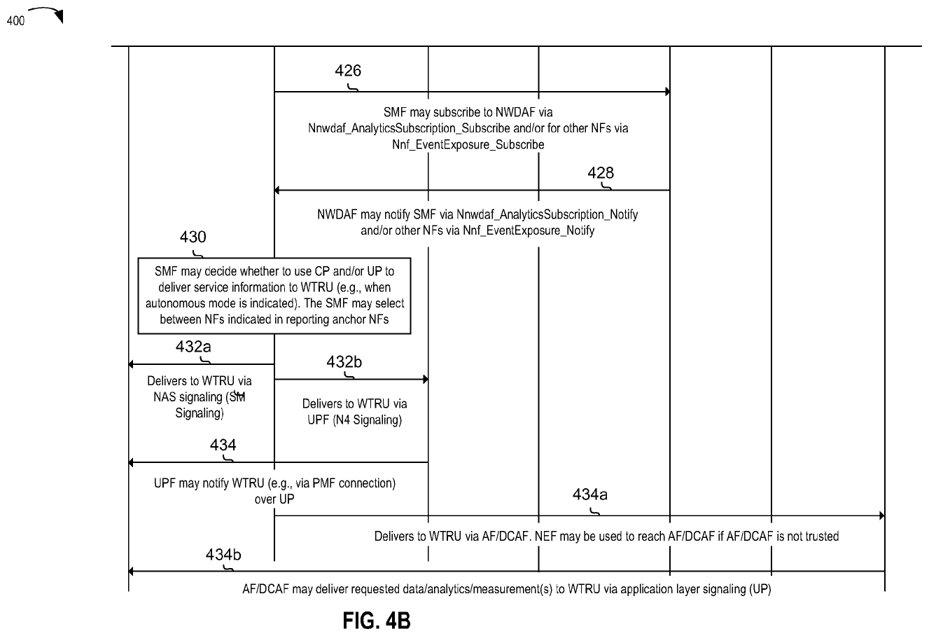

FIGS. 4A, 4B, and 4C depict an example call flow 400 where a WTRU 402 may inform an SMF 404 via NAS signalling regarding the one or more service exposure parameter(s) that have been negotiated between WTRU 402 and the AF 414. Information may be communicated from 5GC to WTRU via CP and/or UP. The SMF 404 may determine (e.g., dynamically determine) whether to send information (e.g., analytics information) to the WTRU 402 via the CP and/or the UP. Analytics information may comprise one or more analytics, service information, data, and/or one or more measurements). The WTRU 402 may send an analytics information request that is negotiated with the AF 414 to the SMF 404 via the NAS signalling (e.g., specifically the SM Signaling, which may terminate at the SMF 404). In the service information request, for example, the WTRU 402/AF 414 may indicate how the SMF 404 may deliver the requested analytics information to the WTRU 402, e.g., whether to use CP (e.g., via NAS signalling) and/or UP (e.g., UPF 406, AF 414).

At 416, the WTRU 402 may establish a PDU Session indicating that the WTRU 402 communicate with (e.g., receive/provide information from/to) the 5GC. The WTRU 402 may indicate to the SMF 404, for example, within the Protocol Configuration Option IE, whether to use the Data Collection Application Function when the Network uses the User Plane to deliver information to the WTRU 402. The SMF 404 may interact with PCF 408/UDM 412 to verify one or more WTRU authorization, for example the PCF 408 and/or the UPF 406 may indicate whether the WTRU 402 is allowed to use Control Plane, User Plane or both for the delivery of information. Verification of the one or more WTRU authorizations may be performed as part of a PDU Session Establishment and Modification procedure.

At 418, the WTRU 402 and the AF 414 may negotiate regarding what analytics information (e.g., data, analytics, and/or measurements, etc.) should be exposed to WTRU 402 and AF 414 and/or in what ways (e.g., CP and/or UP). The WTRU 402 and AF 414 may exchange one or more parameters (e.g., analytics parameters) when negotiating. For example, the one or more analytics parameters exchanged between the WTRU 402 and the AF 414 may be associated with analytics, data, and/or one or more measurement(s). The one or more analytic parameters may include Application ID, WTRU ID (e.g., SUPI), Data; one or more measurements, Reporting anchor NFs (e.g., SMF/AMF, UPF, AF/DCAF), Reporting mode (e.g., Autonomous and/or Fixed), Reporting type (e.g., Request/Response and/or Subscribe/Notify), Target Notification Endpoints (e.g., WTRU 402, AF 414), Notification Correlation ID, etc. Data and/or the one or more measurements may include network load, user data congestion, data network performance analytics, and/or one or more WLAN performance measurements.

At 420, the WTRU 402 may provide one or more negotiated parameters (e.g., analytics parameters) to the SMF 404 via SM signalling (e.g., via a new IE such as an analytics IE). For example, the WTRU 402 may send, at 420, a message to the SMF 404 that indicates one or more of the analytics parameters. For example, the message sent at 420 to the SMF 404 may include a type of analytics information and/or a reporting mode for the analytics information. This IE may include information related to the: one or more Reporting anchor NFs (e.g., SMF 404, UPF 406, AF 414); Reporting mode (e.g., Fixed and/or Autonomous); Reporting type (subscribe/notify, request/response); Target Notification Endpoints (e.g., WTRU 402, AF 414, etc.); data; one or more measurements (e.g., packet delay information from UPF 406, the one or more User Mobility analytics from NWDAF 410, etc.); and/or Notification Correlation ID. Data and/or the one or more measurements may include network load, user data congestion, data network performance analytics and/or one or more WLAN performance measurements.

The WTRU 402/AF 414 may express its preferences regarding the way information is exposed from 5GC to the WTRU 402 (e.g., through UP and/or CP). For example, the WTRU 402 may request (e.g., via the AF 414) to receive information (e.g., analytics information) from the 5GC via the UP and/or CP. The WTRU 402/AF 414 may express its information exposure preferences in one or more scenarios where the WTRU 402 uses one or more (e.g., multiple) access technologies (e.g., over an MA-PDU Session); access may be used for UP while the other access can be used to exchange the one or more CP message(s). The WTRU 402/AF 414 may express its respective information exposure preferences while operating in dual connectivity, where UP may switch from one cell (e.g., bearer) to another cell (e.g., bearer), so the WTRU 402 may decide where it prefers to receive information from 5GC. The WTRU 402 and/or the AF 414 may delegate such decision-making to the 5GC network. For example, the WTRU 402 may allow the 5GC network to determine whether to send analytics information to the WTRU 402 via the UP and/or CP.

A list of one or more NFs that can be used as an anchor node (e.g., in the Reporting Anchor NFs field) may be signalled from the WTRU 402 and/or the AF 414 to the SMF 404 (e.g., in human-readable text). The (e.g., actual) address of the one or more anchor NFs may not be known to the WTRU 402 and/or the AF 414. The WTRU 402 may know the (e.g., actual) address of the AF 414 and/or the UPF/PMF 406.

At 422, the SMF 404 may check with the UDM 412 if the WTRU 402 is authorized to get requested information from 5GC, for example, by invoking the Nudm_SDM_Get service operation. Invoking the Nudm_SDM_Get service operation may include one or more parameter(s) such as one or more Reporting anchor NFs, Reporting mode, Reporting type, requested data and/or analytics and/or one or more measurements, etc. For example, the SMF 404 may send, at 422, a request to one or more NFs indicating they type of analytics information received, at 420, from the WTRU 402.

If the SMF 404 has indicated that a notification should be delivered to the AF 414 (e.g., directly), for example, the NWDAF 410 and/or one or more other NFs may notify (e.g., directly notify) the AF 414. At 424, the SMF 404 may subscribe to analytics information (e.g., requested analytics/data/measurements) on behalf of the WTRU 402 and/or the AF 414. For example, the SMF 404 may subscribe, at 424, to one or more NFs to receive the type of analytics information that was indicated in the message sent, at 420, by the WTRU. If the service producer ID is not indicated by the WTRU 402 and/or the AF 414, the SMF 404 may query NRF to get the corresponding service producer that is serving the WTRU 402 and/or the AF 414. The SMF 404 may subscribe, at 424, to a set of data and/or analytics and/or one or more measurements/statistics to use when determining which reporting anchor NF should be used to (e.g., better) deliver information to the WTRU 402 when the reporting mode is “Autonomous”; for example, whether to use NAS signalling and/or user plane (e.g., UPF or AF). The SMF 404 may subscribe to the User Data Congestion Analytics to predict how congested the CP would be. At 426, the SMF 404 may subscribe to one or more user mobility analytics to predict user mobility (e.g., in dual-connectivity scenarios). For subscribing to the NWDAF 410 and one or more other NFs, the SMF 404 may invoke Nnwdaf_AnalyticsSubscription_Subscribe and Nnef_EventExposure_Subscribe service operations, respectively.

At 428, the NWDAF 410 and/or one or more other NFs may notify the SMF 404 with requested data, analytics, and/or measurements. The NWDAF 410 may request data, analytics, and/or measurements from the SMF 404, for example, via Nnwdaf_AnalyticsSubscription_Notify and/or one or more other NFs via Nnf_EventExposure_Notify.

At 430, the SMF 404 may determine whether to send analytics information to the WTRU 402 via the CP or the UP based on the reporting mode indicated in the message received at 420 from the WTRU. For example, the SMF 404 may determine, at 430, whether to use the CP and/or the UP when the autonomous reporting mode and one or more (e.g., multiple) reporting anchor NFs are indicated (e.g., SMF 404, AF 414, UPF 406) in the PCC rules. The SMF 404 may determine, at 430, whether to send the analytics information to the WTRU 402 via the CP and/or the UP based on network congestion information and/or WTRU mobility information.

If the SMF 404 determines, at 430, to send the analytics information via the CP (e.g., SMF404), for example, the SMF 404 may send the analytics information from the 5GC to the WTRU 402 using a NAS message. The NAS message may be sent via NAS signalling (e.g., more specifically via the SM signalling). For example, the SMF 404 may enable communication between the UPF 406 and the SMF 404 via the CP. For example, the SMF 404 may send one or more messages to the UPF 404 via an N4 interface.

If the SMF 404 determines to send the analytics information via the UP, for example (e.g., at 434), the SMF 404 may send the analytics information (e.g., an instance of the analytics information) to the WTRU 402 via the UPF 406 (e.g., initially via N4 signalling to UPF 406 and/or then from the UPF 406 to the WTRU 402 via the user plane connection). The instance of the analytics information may comprise analytics, data, and/or measurements associated with a specific time period. The SMF 404 may enable communication between the WTRU 402 and the UPF 406 via the UP. For example, the UPF 406 may send one or more NAS messages to the WTRU 402 via the UP. If the SMF 404 determines to send the analytics information via the UP, for example, the SMF 404, in addition or alternatively, may send the analytics information to the WTRU 402 via the AF 414. The SMF 404 may deliver the analytics information to the WTRU 402 via the AF/DCAF 414 (e.g., at 434a). A NEF may be used to reach AF/DCAF 414, for example, the AF/DCAF 414 is not trusted (e.g., at 434a). The AF/DCAF 414 may deliver, at 434b, analytics information to the WTRU 402 via application layer signalling (e.g., the UP).

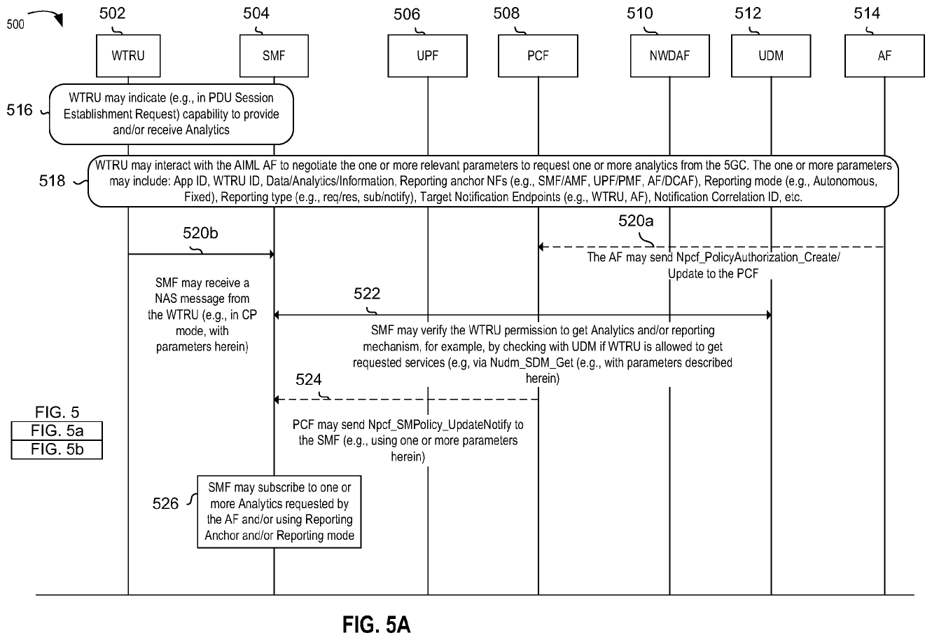

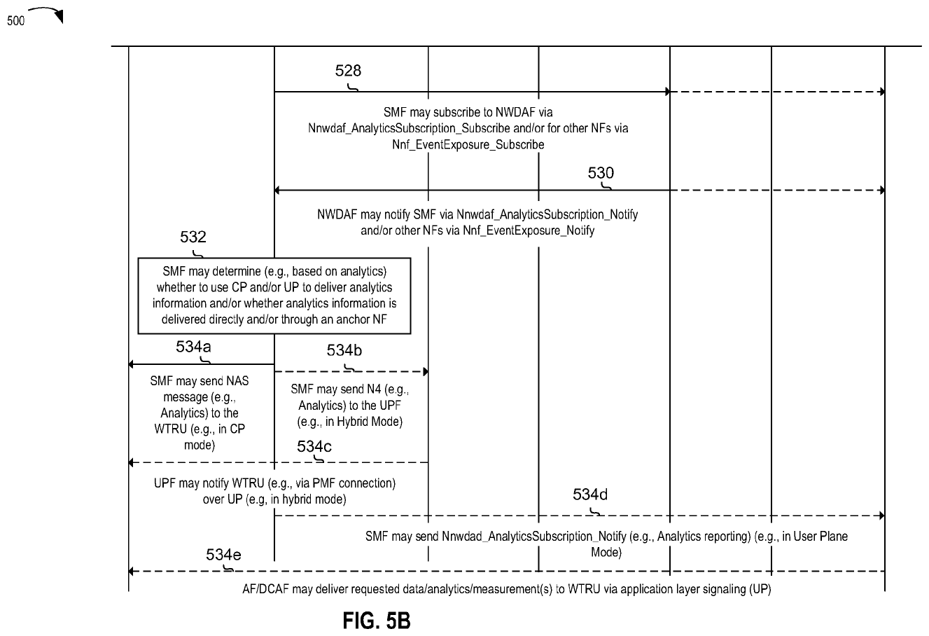

FIGS. 5A and 5B depict an example call flow 500 where a WTRU 502 may inform an SMF 504 via NAS signaling and/or where the AF 514 may inform the SMF 504 regarding one or more parameters (e.g., analytics parameters) that have been negotiated between the WTRU 502 and the AF 514. Information (e.g., analytics information) may be communicated from 5GC to WTRU via CP and/or UP. The SMF 504 may determine (e.g., dynamically determine) whether to send information (e.g., analytics information) to the WTRU 502 via the CP and/or the UP. Analytics information may comprise one or more analytics, service information, data, and/or one or more measurements. The WTRU 502 may send an analytics information request that is negotiated with the AF 514 to the SMF 504 via the NAS signalling (e.g., such as the SM Signaling, which may terminate at the SMF 454). In the service information request, for example, the WTRU 502/AF 514 may indicate how the SMF 504 should deliver the requested analytics information to the WTRU 502, e.g., whether to send the requested analytics information via the CP (e.g., via NAS signalling) and/or the UP (e.g., UPF 506, AF 514).

At 516, the WTRU 502 may establish a PDU Session indicating that the WTRU 502 communicate with (e.g., receive/provide information from/to) the 5GC. The WTRU 502 may indicate to the SMF 504, for example, within a Protocol Configuration Option IE, whether to use a Data Collection Application Function when the Network uses the User Plane to deliver analytics information to the WTRU 502. The SMF 504 may interact with PCF 508 and/or the UDM 512 to verify one or more WTRU authorization, for example the PCF 508 and/or the UPF 506 may indicate whether the WTRU 502 is allowed to use the Control Plane, the User Plane, or both (e.g., Control Plane and User Plane) for the delivery of analytics information. Verification of the one or more WTRU authorization(s) may be performed as part of a PDU Session Establishment and Modification procedure.

At 518, the WTRU 502 and the AF 514 may negotiate what analytics information (e.g., data, analytics, and/or measurements, etc.) should be exposed to the WTRU 502 and the AF 514 and/or in what ways (e.g., CP and/or UP). The WTRU 502 and the AF 514 may exchange one or more parameters (e.g., analytics parameters) when negotiating. For example, the one or more analytics parameters exchanged between the WTRU 502 and the AF 514 may be associated with analytics, data, and/or one or more measurements. The one or more analytic parameters may include Application ID, WTRU ID (e.g., SUPI), Data; one or more measurements, Reporting anchor NFs (e.g., SMF/AMF, UPF, AF/DCAF), Reporting mode (e.g., Autonomous and/or Fixed), Reporting type (e.g., Request/Response and/or Subscribe/Notify), Target Notification Endpoints (e.g., WTRU 502, AF 514), Notification Correlation ID, etc. Data and/or the one or more measurements may include network load, user data congestion, data network performance analytics, and/or one or more WLAN performance measurements.

At 520a, the AF 514 may send negotiated service information to the PCF 508, for example, by invoking Npcf_PolicyAuthorization_Create/Update service operation (e.g., including one or more analytics parameter(s) such as Reporting anchor NFs, Reporting mode, Reporting type, requested data and/or analytics and/or one or more measurements, Notification Correlation ID, etc.). Additionally or alternatively, the WTRU 502 may send, at 520b, one or more negotiated parameters (e.g., analytics parameters) to the SMF 504 via SM signalling (e.g., via a new IE such as an analytics IE, via a NAS message from the WTRU 502). For example, the WTRU 502 may send, at 520b, a (e.g., NAS) message to the SMF 504 (e.g., in Control Plane Mode) that indicates one or more of the analytics parameters. For example, the message sent at 520b to the SMF 504 may include a type of analytics information and/or a reporting mode for the analytics information. The analytics IE may include one or more of the analytics parameters, for example, such as: one or more Reporting anchor NFs (e.g., SMF 504, UPF 506, AF 514); Reporting mode (e.g., Fixed and/or Autonomous); Reporting type (subscribe/notify, request/response); Target Notification Endpoints (e.g., WTRU 502, AF 514, etc.); data; one or more measurements (e.g., packet delay information from UPF 506, the one or more User Mobility analytics from NWDAF 510, etc.); and/or Notification Correlation ID. Data and/or the one or more measurements may include network load, user data congestion, data network performance analytics, and/or one or more WLAN performance measurements.

The WTRU 502/AF 514 may express its preferences regarding the way analytics information is exposed from 5GC to the WTRU 502 (e.g., through UP and/or CP). For example, the WTRU 502 may request (e.g., via the AF 514) to receive analytics information from the 5GC via the UP and/or CP. The WTRU 502/AF 514 may express its information exposure preferences in one or more scenarios where the WTRU 502 uses one or more (e.g., multiple) access technologies (e.g., over an MA-PDU Session); access may be used for UP while the other access can be used to exchange the one or more CP message(s). The WTRU 502/AF 514 may express its respective information exposure preferences while operating in dual connectivity, where UP may switch from one cell (e.g., bearer) to another cell (e.g., bearer), so the WTRU 502 may decide where the WTRU 502 prefers to receive information from 5GC. The WTRU 502 and/or the AF 514 may delegate such decision-making to the 5GC network. For example, the WTRU 502 may allow the 5GC network to determine whether to send analytics information to the WTRU 502 via the UP and/or CP.

A list of one or more NFs that can be used as an anchor node (e.g., in the Reporting Anchor NFs field) may be signalled from the WTRU 502 and/or the AF 514 to the SMF 504 (e.g., in human-readable text). The (e.g., actual) address of the one or more anchor NFs may not be known to the WTRU 502 and/or the AF 514. The WTRU 502 may know the (e.g., actual) address of the AF 514 and/or the UPF/PMF 506.

At 522, the SMF 504 may verify with the 5GC (e.g., the UDM 512) if the WTRU 502 is authorized to get requested information from 5GC, for example, by invoking the Nudm_SDM_Get service operation. Invoking the Nudm_SDM_Get service operation may include one or more (e.g., analytic) parameter(s) such as one or more Reporting anchor NFs, Reporting mode, Reporting type, requested data and/or analytics and/or one or more measurements, etc. For example, the SMF 504 may send, at 522, a request to one or more NFs indicating the type of analytics information received (e.g., at 520b) from the WTRU 502. If the SMF 504 has indicated that a notification should be delivered to the AF 514 (e.g., directly), for example, the NWDAF 510 and/or one or more other NFs may notify (e.g., directly notify) the AF 514.

At 524, additionally or alternatively, the PCF 508 may update one or more dynamic PCC rule(s) in the SMF 504, for example, verifying the WTRU permission with the UDM 512. The PCF 508 may invoke the Npcf_SMPolicy_UpdateNotify service operation (e.g., including one or more parameter(s) such as Reporting anchor NFs, Reporting mode, Reporting type, requested data and/or analytics and/or one or more measurements, Notification Correlation ID, etc.). One or more PCC rules associated with information exposure to the WTRU 502 may be defined herein. The one or more PCC rules may include information associated with the Reporting anchor NFs, Reporting mode, Reporting type, etc.

At 526, the SMF 504 may subscribe to analytics information (e.g., requested analytics/data/measurements), for example, on behalf of the WTRU 502 and/or the AF 514. For example, the SMF 504 may subscribe, at 526, to one or more NFs to receive the type of analytics information that was indicated in the message sent, at 520b, by the WTRU 502. If the service producer ID is not indicated by the WTRU 502 and/or the AF 514, the SMF 504 may query NRF to get the corresponding service producer that is serving the WTRU 502 and/or the AF 514. The SMF 504 may subscribe, at 526, to a set of data and/or analytics and/or one or more measurements/statistics to use when determining which reporting anchor NF should be used to (e.g., better) deliver information to the WTRU 502 when the reporting mode is “Autonomous”; for example, whether to use NAS signalling and/or user plane (e.g., UPF and/or AF). The SMF 504 may subscribe to the User Data Congestion Analytics to predict how congested the CP would be.

At 528, the SMF 504 may subscribe to one or more user mobility analytics to predict user mobility (e.g., in dual-connectivity scenarios). For subscribing to the NWDAF 510 and one or more other NFs, the SMF 504 may invoke Nnwdaf_AnalyticsSubscription_Subscribe and/or Nnef_EventExposure_Subscribe service operations, respectively.

At 530, the NWDAF 510 and/or one or more other NFs may notify the SMF 504 with requested data, analytics, and/or measurements. The NWDAF 510 may request data, analytics, and/or measurements from the SMF 504, for example, via Nnwdaf_AnalyticsSubscription_Notify and/or one or more other NFs via Nnf_EventExposure_Notify.

At 532, the SMF 504 may determine whether to send analytics information to the WTRU 502 via the CP and/or the UP based on the reporting mode indicated in the message received (e.g., at 520b) from the WTRU. For example, the SMF 504 may determine (e.g., at 532) whether to use the CP and/or the UP when the autonomous reporting mode and/or one or more (e.g., multiple) reporting anchor NFs are indicated (e.g., SMF 504, AF 514, UPF 506) in the PCC rules. The SMF 504 may determine, at 532, whether to send the analytics information to the WTRU 502 via the CP and/or the UP based on network congestion information and/or WTRU mobility information.

If the SMF 504 determines, at 532, to send the analytics information via the CP (e.g., SMF 504), for example, the SMF 504 may send (e.g., at 534a) the analytics information from the 5GC to the WTRU 502 using a NAS message. The NAS message may be sent via NAS signalling (e.g., more specifically via the SM signalling). For example, the SMF 504 may enable communication between the UPF 506 and the SMF 504 via the CP. For example, the SMF 404 may send one or more messages to the UPF 404 via an N4 interface.

Additionally or alternatively, the SMF 504 may determine to send the analytics information via the UP. If the SMF 404 determines to send the analytics information via the UP, for example (e.g., at 534b), the SMF 454 may send (e.g., at 534b) the analytics information (e.g., an instance of the analytics information) to the WTRU 502 via the UPF 506 (e.g., initially via N4 signalling to UPF 506 and/or then from the UPF 506 to the WTRU 502 via the user plane connection). The instance of the analytics information may comprise analytics, data, and/or measurements associated with a specific time period. The SMF 504 may enable communication between the WTRU 502 and the UPF 506 via the UP. For example, the UPF 506 may send (e.g., at 534c) one or more NAS messages to the WTRU 502 via the UP. If the SMF 504 determines to send the analytics information via the UP, for example, the SMF 504, in addition or alternatively, may send the analytics information to the WTRU 502 via the AF 514. The SMF 504 may deliver the analytics information to the WTRU 502 via the AF/DCAF 514 (e.g., at 534d). A NEF may be used to reach AF/DCAF 514, for example, the AF/DCAF 514 is not trusted (e.g., at 434a). The AF/DCAF 514 may deliver, at 534e, analytics information to the WTRU 502 via application layer signalling (e.g., the UP).

Systems, methods, and apparatuses provided herein may include a Packet Train Monitoring Function (PTMF) that may be provided at the UPF. Once PTMF is activated within the UPF, for example, the PTMF may collect one or more statistics regarding packet inter-arrival pattern/rate/gap. The PTMF may send the one or more statistics to a NWDAF, for example, to predict the end-to-end available bandwidth and/or traffic pattern and/or network jitter. The PTMF may operate on a per PDU Session, QFI, S-NSSAI, NSI, and/or application basis.

One or more PTMF function(s) may be integrated into the PMF at the WTRU and/or the UPF. In examples, the PMF can also monitor the one or more inter-arrival rate of packets for DL and/or UL directions as well as one or more other activities such as measurements of RTT, packet loss rate, and/or packet error rate. Like the NATA, the PTMF component and/or its PMF variant can configure the Traffic Control (TC) function of the underlying operating system (e.g., Linux Kernel, Android, Apple IOS, etc.) dynamically, for example, to get traffic mirroring function on one or more different granularities simultaneously.

A Packet Train Information NWDAF may be a NWDAF with Analytics ID. One or more state inputs to the Packet Train Information NWDAF may be retrieved from the PTMF and/or the PMF/UPF (e.g., via the SMF and/or directly if the UPF supports the SBI). A PTI instance may use one or more other existing analytics at 5GC (e.g., as input) to produce its predictions/statistics (e.g., predicting level of jitter and/or traffic pattern and/or end-to-end available bandwidth for DL and/or UL traffic at the UPF).

The one or more NWDAF (PTI) predictions (e.g., estimation of available bandwidth end-to-end for DL and/or UL) can be fed to the WTRU and/or the AF at the same time, for example, so that they can handle the FL operations (e.g., gracefully). The AF may use the one or more NWDAF (PTI) predictions to select participants. The WTRU may use the one or more NWDAF (PTI) predictions to adjust one or more behaviors.

The one or more NWDAF (PTI) predictions for the UL may be more accurate than one or more predictions produced by the NATA, for example, because the NWDAF (PTI) receives its main input(s) from the PTMF/PMF at the UPF, which monitors packets that come from the access network (e.g., the condition of AN is also reflected in the packets arrival patterns). However, in the case of the NATA, the prediction for UL may not be (e.g., completely) accurate. DL packet monitoring may be delegated to the NATA at the WTRU and/or the UL packet monitoring may be delegated to the PTMF at the UPF. Additionally or alternatively, the AF/AS may monitor the arrival of one or more UL packets.

A WTRU Compute Information NWDAF may be used to predict computing resources of a WTRU and/or a group of WTRUs (e.g., regularly). These one or more computing resources could be GPU and/or CPU and/or memory. An NWDAF instance may collect the (e.g., required) information from the WTRU either through the AF (e.g., user plane) and/or the 5GC control plane (via SMF/AMF) and/or the UPF/PMF, as described herein.

The NWDAF may request the SMF/AMF to collect data from the WTRU through the control plane. In examples, the NWDAF may provide the WTRU ID/PDU Session ID to the SMF/AMF. The AF may use the WTRU Computational Resources analytics and/or one or more other available analytic(s) at the 5GC (e.g., WTRU Communication analytics, DN Performance analytics, slice load level information analytics, etc.) in selecting and/or managing one or more FL participants (e.g., WTRUs). When the (e.g., required) information is collected via the UPF, the 5GC may interact with the WTRU partially through the user plane (e.g., through PMF if enabled at WTRU and/or UPF). When the 5GC communicates with the WTRU through the user plane, for example, network congestion within the 5GC control plane may be reduced. As the number WTRUs using such interactions increases over time, for example, congestion within the 5GC control plane may become a problem. Transferring one or more statistics regarding computing resources from WTRU and/or a group of WTRUs to the NWDAF with a short time interval may create additional network congestion and/or increase the load on the control plane.

When the (e.g., required) information is collected via the AF, for example, the NWDAF may receive one or more measurement(s) associated with the one or more WTRU(s) through the AF. For example, the AF may collect information regarding the CPU, GPU, and/or memory usage report, the number of active applications at the WTRU and/or their types. Additionally or alternatively, the NWDAF may provide a set of predictions regarding WTRU's CPU, GPU, and/or memory usage to the AF.

The AF may select and/or manage one or more FL participant(s)/WTRU(s) using the WTRU Compute Information analytics and/or one or more other available information/analytics at the 5GC (e.g., the WTRU Communication analytics, the DN Performance analytics, the Slice Load Level Information analytics, etc.) and/or one or more (e.g., some) other analytics received from WTRU (e.g., Network and Application Traffic analytics).

What is claimed is:

1.-20. (canceled)

21. A network node comprising:
a processor configured to:
receive information for providing analytic information to a wireless transmit/receive unit (WTRU), the information comprising an indication of a type of analytic information to be provided to the WTRU and a reporting mode for the analytic information, the reporting mode indicating that the network node can dynamically determine a method for delivering the analytic information to the WTRU;
subscribe to receive the indicated type of analytic information;
determine whether to deliver an instance of the analytic information to the WTRU via a control plane or a user plane, wherein the instance of the analytic information is delivered via a non-access stratum information if the network node determines to deliver the instance of the analytic information via the control plane and the instance of the analytic information is delivered via one or more of a user plane function (UPF) or an application function (AF) if the network node determines to deliver the instance of the analytic information via the data plane; and
send the instance of the analytic information to the WTRU via one of the control plane or the user plane.

22. The network node of claim 21, wherein the processor is further configured to:
subscribe to receive one or more of network congestion information or WTRU mobility information; and
use the network congestion information or WTRU mobility information to determine whether to deliver the instance of the analytic information to the WTRU via the control plane or the user plane.

23. The network node of claim 21, wherein the analytic information comprises one or more of a predicted level load on a network slice used for an artificial intelligence (AI)/machine learning) application, a predicted end-to-end available bandwidth, a level of end-to-end jitter for downlink or uplink, or a traffic pattern.

24. The network node of claim 21, wherein the processor is configured to determine whether to deliver the instance of the analytic information to the WTRU via the control plane or the user plane based on information collected by one or more network functions (NFs).

25. The network node of claim 24, wherein the processor is configured to determine whether to deliver the instance of the analytic information to the WTRU via the control plane or the user plane based on one or more policy and charging control (PCC) rules.

26. The network node of claim 21, wherein the processor being configured to send the instance of the analytic information comprises the processor being configured to send an artificial intelligence (AI)/machine learning (ML) model to the WTRU, wherein a plurality of WTRUs comprises the WTRU, and wherein at least the plurality of WTRUs comprise a global model of the AI/ML model.

27. The network node of claim 21, wherein the analytic information comprises information configured to enable the WTRU to modify a packet data unit (PDU) session to modify one or more quality of service (QOS) related parameters or to switch between a central processing unit (CPU) or a graphics processing unit (GPU).

28. The network node of claim 21, wherein the network node is further configured to subscribe to a set of information to determine one or more anchor network functions (NFs) to use to send the instance of the analytic information to the WTRU.

29. The network node of claim 21, wherein the processor is configured to determine whether to use the to deliver the instance of the analytic information to the WTRU via the control plane or the user plane based on an exchange of information between the WTRU and the AF.

30. The network node of claim 21, wherein the information exchanged between the WTRU and the AF comprises one or more an application identifier (ID), a WTRU ID, analytics information, measurement information, one or more reporting anchor network functions (NFs), a reporting type, one or more target notification endpoints, or a notification correlation ID.

31. A method performed by a network node, the method comprising:
receiving information for providing analytic information to a wireless transmit/receive unit (WTRU), the information comprising an indication of a type of analytic information to be provided to the WTRU and a reporting mode for the analytic information, the reporting mode indicating that the network node can dynamically determine a method for delivering the analytic information to the WTRU;
subscribing to receive the indicated type of analytic information;
determining whether to deliver an instance of the analytic information to the WTRU via a control plane or a user plane, wherein the instance of the analytic information is delivered via a non-access stratum information if the network node determines to deliver the instance of the analytic information via the control plane and the instance of the analytic information is delivered via one or more of a user plane function (UPF) or an application function (AF) if the network node determines to deliver the instance of the analytic information via the data plane; and
sending the instance of the analytic information to the WTRU via one of the control plane or the user plane.

32. The method of claim 31, further comprising:
subscribing to receive one or more of network congestion information or WTRU mobility information; and
using the network congestion information or WTRU mobility information to determine whether to deliver the instance of the analytic information to the WTRU via the control plane or the user plane.

33. The method of claim 31, wherein the analytic information comprises one or more of a predicted level load on a network slice used for an artificial intelligence (AI)/machine learning) application, a predicted end-to-end available bandwidth, a level of end-to-end jitter for downlink or uplink, or a traffic pattern.

34. The method of claim 31, wherein determining whether to deliver the instance of the analytic information to the WTRU via the control plane or the user plane is based on information collected by one or more network functions (NFs).

35. The method of claim 34, wherein determining whether to deliver the instance of the analytic information to the WTRU via the control plane or the user plane is based on one or more policy and charging control (PCC) rules.

36. The method of claim 31, wherein sending the instance of the analytic information comprises sending an artificial intelligence (AI)/machine learning (ML) model to the WTRU, wherein a plurality of WTRUs comprises the WTRU, and wherein at least the plurality of WTRUs comprise a global model of the AI/ML model.

37. The method of claim 31, wherein the analytic information comprises information configured to enable the WTRU to modify a packet data unit (PDU) session to modify one or more quality of service (QOS) related parameters or to switch between a central processing unit (CPU) or a graphics processing unit (GPU).

38. The method of claim 31, further comprising subscribing to a set of information to determine one or more anchor network functions (NFs) to use to send the instance of the analytic information to the WTRU.

39. The method of claim 31, further comprising determining whether to use the to deliver the instance of the analytic information to the WTRU via the control plane or the user plane based on an exchange of information between the WTRU and the AF.

40. The method of claim 31, wherein the information exchanged between the WTRU and the AF comprises one or more an application identifier (ID), a WTRU ID, analytics information, measurement information, one or more reporting anchor network functions (NFs), a reporting type, one or more target notification endpoints, or a notification correlation ID.
